(19) United States
(12) Patent Application Publication
(10) Pub. No.: US 2011/0139356 A1
(43) Pub. Date: Jun. 16, 2011

(54) Method of manufacturing coating elements and production installation relating thereto

(76) Inventor: Jorg Pohe, Oldendorf (DE)

(21) Appl. No.: 12/653,448

(22) Filed: Dec. 14, 2009

(51) Int. Cl. B32B 37/14

(52) U.S. Cl. 156/229; 156/494

(57) ABSTRACT

The invention entails a method of producing at least one coating element, more particularly at least one decorative layer suitable for coating at least one carrier board (60), whereby
through unrolling raw fibre material or raw paper, more particularly raw decorative paper, at least one fibre material or paper web (50) is stretched out and
the stretched out fibre material or paper web (50) is at least partially printed with colour and/or at least one patter or decoration,
   as well as production installation (100) relating thereto, in such a way that the coating element can be efficiently produced while reliably avoiding kinks, cracks or changes in shape of the printed fibre material or paper web. After printing the stretched out fibre material or paper web (50) may be at least in parts
impregnated with at last one resin, more particularly at least one animoplastic and/or thermally hardening synthetic resin, for example melamine resin, and/or
coated with a layer containing at least one resin, more particularly an aminoplastic and/or thermally hardening synthetic resin, for example melamine resin.

### FIELD OF THE INVENTION

Laminate is a layered pressed material formed by pressing, adhering and/or gluing together at least two layers of the same and/or different material.

A laminate that is used, for example, as a floor, as a wall or ceiling cladding, as a work top or for manufacturing furniture has at least one carrier board which is coated with at least one coating element, more particularly with at least one decorative layer or decorative paper with thermally hardening resin.

The carrier board is usually a composite wood board, such as a fibre board, for example a high-density fibreboard (HDF) or a medium-density fibreboard (MDF) or a particle board, or a composite wood board made of orientated micro veneers, known as an O[riented]S[trand]B[oard].

Decisive for the optical appearance of the laminate is the decorative layer which is applied to the upper side of the carrier board. The decorative paper of the decorative layer can be printed with a colour and/or a pattern or decoration, for example a wood or stone reproduction.

To improve the wear resistance of the laminate the decorative paper is usually impregnated with thermally-hardening synthetic resin, for example melamine resin, and/or coated with an abrasion-resistant layer, known as the overlay.

The overlay consists of thermally-hardening synthetic resin, for example melamine resin. For improved resin uptake the overlay can also consist of fibrous, more particularly cellulose-containing, material. In order to improve its abrasion resistance this fibrous synthetic resin layer can also be provided with abrasion-resistant and/or abrasive substance such as corundum particles for instance. The overlay can for example consist of two transparent melamine resin-impregnated papers, between which a corundum layers is included. Corundum-filled overlays are also usual.

On the side of the coating element facing the carrier board a core or carrier paper layer of several papers impregnated with thermally hardening synthetic resin, for example phenol resin, can be arranged. This optional paper layer, in which kraft paper is preferably used as the paper, provides the covering layers with additional hardness and impact resistance and improves its standing ability.

To improve the dimensional stability of the laminate element, the underside of the carrier board can be pressed with a backer sheet, for example a veneer or another layer impregnated with a thermally hardening synthetic resin.

In the manufacturing of laminate a distinction is made between a single stage and dual stage manufacturing process. In the single stage manufacturing process the various layers, i.e. the decorative layer of decorative paper and thermally hardening synthetic resins, which can, for example, be applied in the form of an overlay on the decorative paper, the carrier board and the optional backer sheet are pressed together in one operation to form a direct pressure laminate (DPL).

In the dual-stage method on the other hand, in a first stage a coating element is produced from the decorative paper and the thermally-hardening resin which, for example, can be applied to the decorative paper in the form of an overlay, and the optional core or carrier paper layer. In a second stage the coating element is then pressed with the carrier board. These laminate manufacturing methods are described in DIN standards DIN EN 14322, DIN EN 438-2 and DIN EN 13329. With regard to the technical background of laminate manufacturing reference is made to document WO 2007/079547 A1.

In the known laminate manufacturing processes the decorative layer of decorative paper and thermally-hardening synthetic resin is produced in two working stages on two separate production installations. First of all the decorative paper is printed on a first production installation, whereby the printing using takes place using the intaglio process. The printed decorative paper is then rolled up and transported to a second installation for impregnation or coating with thermally hardening synthetic resin. At the second production installation the printed paper is then impregnated with the thermally hardening synthetic resin or is coated with the overlay.

However, producing the decorative layer on two separate production installations and/or in two separate production stages is not very efficient as the raw decorative paper has to be transported to two different production installations and positioned in each one of these. In the first production installation a paper web of raw paper is stretched out for printing and in the second production installation a second paper web of printed paper is stretched out for impregnation or coating of the paper. This method of product is time and therefore cost-intensive. Two separate production installations also require a relatively large amount of space.

Another drawback is that stretching out the paper web twice can lead to a change in the shape of the decorative paper and thereby deformation or distortion of the printed pattern as wall as to kinking and/or tearing of the decorative paper.

In document DE 600 15 603 T2 it is proposed, in order to avoid match imprecisions of the pattern of a laminate floor, to print this pattern directly onto the carrier board, thus for example directly onto the composite wood board by means of a digital printer. However, the drawback of this is that the surface of the carrier board has to be treated before printing, for example primed and/or ground. Also, in the case of the laminate element in accordance with document DE 600 15 603 T2 only transparent layers can be applied to the carrier board. For example, it is not possible to apply a core or carrier paper layer of kraft pulp to the carrier board.

### BRIEF DESCRIPTION OF THE FIGURE

FIG. 1 shows a schematic view of a first example of embodiment of a device in accordance with the present invention which operates in accordance with the method of producing or finishing laminate according to the present invention.

### DESCRIPTION OF THE INVENTION

With the above in mind, the inventors developed a method and a production installation such that the coating element can be efficiently manufactured, while reliably avoiding kinks, tears or changes in the shape of the printed fibre material or paper.

This is achieved by means of a method and production installation with the features described below. Advantageous embodiments and expedient further developments of the present invention are also described.

The present invention is fundamentally based on designing a series or in-line production installation, such as an production line, in which the fibre material or paper is printed in a first stage and then immediately further processed by means of impregnation and/or coating. In accordance with the present invention the supplied fibre material or paper is printed in one production stage and then impregnated and/or coated in the same production stage.

According to the invention, in order to produce at least one coating element, more particularly for producing a decorative coating made of fibre material and resin, more particularly decorative paper and amino-plastic and or thermally hardening synthetic resin for coating at least one carrier board, at least one fibre material or paper web is initially stretched out by unrolling raw fibre material or raw paper, more particularly raw decorative paper. This stretched fibre material or paper web is at least partially printed with colour and/or with at least one pattern or decoration. The stretched out and printed fibre material or paper web is then at least in parts
impregnated with at least one resin with at least one aminoplastic and/or thermally hardening synthetic resin, for example, melamine resin and/or
coated with a layer containing at least one resin, more particularly at least one aminoplastic and/or thermally hardening synthetic resin, for example melamine resin, for example with a so-called overlay.

Combining printing and impregnation and/or coating in one production installation or one machine can be achieved by arranging at least one impregnating and/or coating device in series or in line with at least one printing device. For example, the printing device can be arranged between at least one unrolling device for unrolling the fibre material or paper web, and a first immersion bath, or a first coating device of the impregnating and/or coating device. The unrolling device, printing device and/or coating device are preferably arranged in series, for example on at least one production band or production line, such as on at least one impregnating channel.

In accordance with an advantageous embodiment of the present invention the production installation has the components of a conventional impregnation and/or coating installation. However, these components are arranged so that the stretched out fibre material or paper web can be printed as well as impregnated and/or coated.

The fibre material or paper web can be printed by intaglio printing or by means of digital printing. Using the digital printing method is particularly advantageous as a digital printing device requires little space and can thus be simply integrated into a conventional impregnation machine. Furthermore, a digital printing device or digital printer does not require cost-intensive printing plates. Other advantages of a digital printing system compared with intaglio printing are the lower investment costs as well as the possibility of simpler and more cost-effective decoration changing. In addition, with a digital printing system raw material storage costs can be reduced as a large number of decorations does not have to be kept in stock.

In accordance with an advantageous embodiment of the present invention the fibre material or paper web is printed by at least one digital printing device. This digital printing device exhibits the properties required for printing the fibre material or paper web and is preferably designed to essentially print the entire width of the fibre material or paper web.

Advantageously the digital printer device is designed to dry the printed fibre material or paper web at least in parts. Drying of the fibre material or paper web can take place by means of air and/or ultra-violet radiation and/or using the method of near infra-red drying. In addition to pure air drying other drying methods, such as UV drying and NIR drying can be used.

Due to its comparatively low printing speed an advantageous embodiment of the printer device has a comparatively short drying section, a few metres in length for example.

After passing through the printing device or printer the known impregnation and/or coating procedure can continue unchanged. For example, the stretched out fibre material or paper web with at least one resin, more particularly at least one aminoplastic and/or thermally hardening synthetic resin, for example melamine resin, can be saturated/impregnated and after saturation or impregnation with
at least one resin, more particularly at least one aminoplastic and/or thermally hardening synthetic resin, for example melamine resin, and/or
fibre material, more particularly cellulose, and/or
provided with a least one layer containing an abrasion-resistant substance, more particularly corundum.

Furthermore, the stretched out fibre material or paper web can, more particularly on its side facing away from the layer with resin, be coated with a core or carrier paper layer, whereby the core or carrier paper layer has at least one fibre material, more particularly paper, for example kraft paper, impregnated with a thermally-hardening synthetic resin, for example phenol resin.

The present invention also relates to a method of producing laminate, for example at least one laminate floor element, at least one laminate work top, a least one wall or ceiling cladding element of a laminate or at least one laminate furniture element, as well an installation relating thereto. In accordance with the invention, to produce laminate
at least one coating element is produced by way of a method in accordance with the above type and
then applied to at least one carrier board, more particularly glued and/or stuck and/or pressed to it.

According to an advantageous further embodiment of the method according to the invention for producing a coating element as well as the production installation according to the invention, the stretched out fibre material or paper web of the coating element can also immediately, i.e. in the same production stage, be applied to the carrier board, for example a composite wood board, such as an MDF, HDF, OSB or particle board, or to a plastic board.

In addition, on its side facing away from the coating element, the carrier board can in the same production stage also be coated with at least one backer sheet, for example with at least one veneer and/or with at least one further layer with a thermally-hardening resin. The coating element can be laminated onto the carrier board by means of single-stage or dual-stage process. From the coating element produced in accordance with the invention D[irect]P[ressure]L[aminat], H[igh]P[ressure]L[aminat] as well as C[ontinuous]P[ressure]L[aminat] and also L[ow]P[ressure]L[aminat] can be produced.

The present invention finally relates to the use of a method for producing at least one coating element in accordance with the manner set out above and/or at least one production installation of the above-described type
for the line or series production of printed, impregnated and/or coated decorative paper and/or
for the line or series production of laminate, more particularly by means of a method for production of a laminate of the above-described type and/or by means of at least one device for producing laminate in accordance with type described above.

As has already been stated, there are various possibilities of advantageously embodying and further developing the teaching of the present invention. For instance, the invention entails a method of producing at least one coating element, more particularly a decorative layer suitable for covering at least one carrier board (60), whereby
through unrolling raw fibre material or raw paper, more particularly a raw decorative paper, at least one fibre material or paper web (50) is stretched out and
the stretched out fibre material or paper web (50) is printed at least in parts with colour and/or at least one pattern/decoration,
characterised in that
after printing, the stretched out fibre material or paper web (50) is, more particularly in an in-line process, at least in parts
impregnated with at last one resin, more particularly at least one animoplastic and/or thermally hardening synthetic resin, for example melamine resin, and/or
coated with at least a layer containing at least one resin, more particularly an aminoplastic and/or thermally hardening synthetic resin, for example melamine resin.

The method may further be characterised in that after printing and before impregnation the stretched out fibre material or paper web (50) is at least partially dried, whereby drying of the fibre material or paper web (50) takes place in particular by means of air and/or by means of ultra-violet radiation and/or by means of the method of near infra-red drying.

Optionally, the printing of the fibre material or paper web (50) takes place by means of digital printing or intaglio printing.

In one variant of the method of producing laminate, at least one coating element is produced using a method in accordance with the above-described method and that subsequently the coating element, more particularly the stretched out, printed, impregnated and/or coated fibre material or paper web (50) is applied, more particularly glued and/or stuck and/or pressed, onto at least one carrier board.

The invention also entails a production installation (100) for producing at least one coating element, more particularly at least one decorative layer suitable for coating at least one carrier board (60), comprising
an unrolling device (10) for stretching out at least one fibre material or paper web (50) by means of unrolling raw fibre material or raw paper, more particularly raw decorative paper, and
at least one printing device (20) for printing the stretched out fibre material or paper web (50) at least in parts with colour and/or at least one pattern/decoration,
characterised in that
there is at least one impregnating and/or coating device (30) that is arranged in series with the printing device (20) and is designed
for impregnating, at least in parts, the stretched out fibre material or paper web (50) with at least one resin, more particularly with at least one aminoplastic and/or thermally hardening resin, for example melamine resin, and or
for coating, at least in parts, the stretched out fibre material or paper web (50) with at least one resin, more particularly with at least one aminoplastic and/or thermally hardening synthetic resin, for example melamine resin.

In another aspect, the printing device (20)
is arranged between the unrolling device (10) and the impregnating and/or coating device (30) and/or
is designed to print the fibre material or paper web (50) by means of the method of digital printing or by means of the method of intaglio printing.

In another aspect, the production installation is characterised by at least one drying device (22)
allocated to the printing device (20) or
arranged in series with the printing device (20) and the impregnating and/or coating device (30), more particularly between the printing device (20) and the impregnating device (30), for at least partially drying the fibre material or paper web (50) more particularly by means of air and/or ultra-violet radiation and/or the method of near infra-red drying.

In another aspect, the production installation according is characterised in that the layer with resin also contains fibre material, more particularly cellulose and/or at least one abrasion-resistant or abrasive substance, more particularly corundum.

The invention also entails a device (200) for producing laminate, characterised by
at least one production installation (100) as described above and
at least one lamination device (210) designed for applying the coating material, more particularly the stretched out, printed, impregnated and/or coated fibre material or paper web (50) to at least one carrier board (60).

The invention also entails the use of a method of producing at least one coating element such as is described above, and/or at least one production installation (100) such as is described above
for the inline or series production of printed, impregnated and/or coated decorative paper and/or
for the inline or series production of laminate, more particularly by means
   of a method of producing laminate whereby at least one coating element is produced using a method in accordance with the above-described method and that subsequently the coating element, more particularly the stretched out, printed, impregnated and/or coated fibre material or paper web (50) is applied, more particularly glued and/or stuck and/or pressed, onto at least one carrier board.
   and/or at least one device (200) for producing laminate which includes at least one production installation (100) as described above and at least one lamination device (210) designed for applying the coating material, more particularly the stretched out, printed, impregnated and/or coated fibre material or paper web (50) to at least one carrier board (60).

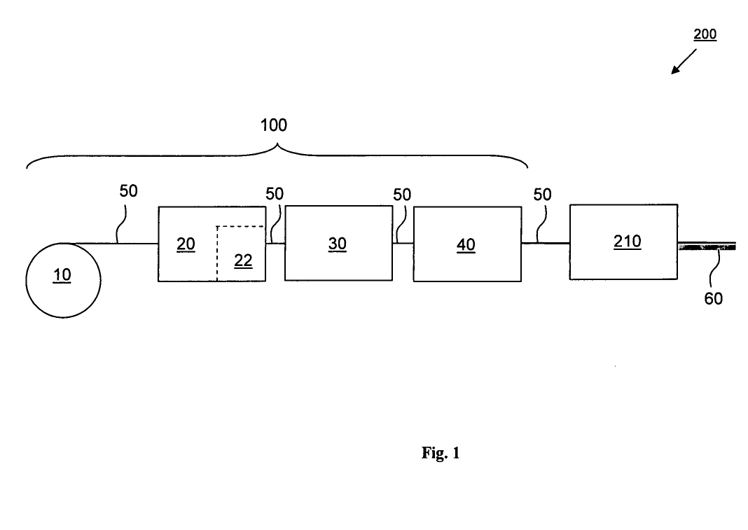

Further embodiments, feature and advantages of the present invention are explained in more detail below with the aid of the example of embodiment illustrated in FIG. 1.

In the first example of embodiment of the present invention illustrated in FIG. 1, an installation 200, more particularly a production line, for producing laminate is shown which operates in accordance with the present invention and has several functional components, namely
an example of embodiment of a production installation 100 for producing at least one coating element in accordance with the present invention, whereby the production installation 100 operates in accordance with the method of producing at least one coating element according to the present invention and
a laminating device 210 for applying the coating element, more particularly the stretched out, printed, impregnated and/or coated fibre material or paper web 50 to a carrier board 60.

The production installation 100 is designed for the production of a decorative layer suitable for coating the carrier board 60, whereby the decorative layer comprises at least one printed decorative paper and thermally-hardening synthetic resin.

For this purpose the production installation 100 has
an unrolling device 10 designed for stretching out a fibre material or paper web 50 by means of unrolling raw fibre material or raw paper, more particularly raw decorative paper,
a printing device 20 for printing the stretched out fibre material or paper web 50 with colour and/or at least one pattern or decoration,
an impregnating and/or coating device 30, namely an impregnating device 30 arranged in series or in line with the printer device 20.

This impregnating device 30 is designed for impregnating the stretched out fibre material or paper web 50 with aminoplastic and thermally hardening synthetic resin, namely melamine resin. Furthermore, the impregnating device 30 can also be deigned for coating the stretched out fibre material or paper web 50 with a layer comprising a resin, more particularly melamine resin, i.e. with an overlay.

However, in the example of embodiment shown in FIG. 1, the production installation 100 has a coating unit 40 arranged in series or in line with the impregnating unit 30 for coating the stretched out fibre material or paper web 50 with the overlay.

The printing unit 20 is arranged between the unrolling device 10 and the impregnating unit and is designed for printing the fibre material or paper web 50 by means of the digital printing method.

For the at least partial drying of the printed fibre material or paper web 50, the printing device 20 has a drying device 22. Alternatively (not shown in FIG. 1), this drying device 22 can also be arranged in series or in line with the printing device 20 and the impregnating device 30, more particularly between the printing device 20 and the impregnating device 30.

In contrast to the methods known and practised in the state of the art, in which in two separate working stages the decorative paper is first printed, generally using the intaglio method, and then in another installation is impregnated in a second stage, the production installation 100 shown in FIG. 1 performs an inline process for printing and impregnating and/or coating decorative paper. One novel aspect of the invention is the fact that this takes place inline during the course of one working process, i.e. on a production installation or machine.

### LIST OF REFERENCES

10 Unrolling device
20 Printing device, more particularly digital printer or intaglio printer
22 Drying device
30 Impregnating and/or coating device
40 Coating device
50 Fibre material or paper web
60 Carrier board, more particularly composite wood board or plastic board
100 Production installation or finishing installation, more particularly a finishing line for producing a coating element, more particularly a decorative layer suitable for coating a carrier board 60
200 Installation, more particularly production line for producing laminate
210 Lamination device

1. A method of producing at least one coating element, whereby through unrolling raw fibre material or raw paper, at least one fibre material or paper web is stretched out and is printed at least in parts with colour and/or at least one pattern/decoration,
wherein after printing, the stretched out fibre material or paper web is at least in parts impregnated with at least one resin, and/or coated with at least a layer containing at least one resin.

2. The method according to claim 1, wherein the coating element is a decorative layer suitable for covering at least one carrier board.

3. The method according to claim 1, wherein the raw fibre material or raw paper is a raw decorative paper.

4. The method according to claim 1, wherein the process is in-line process.

5. The method according to claim 1, wherein the at least one resin is an animoplastic and/or thermally hardening synthetic resin.

6. The method according to claim 5, wherein the resin is melamine resin.

7. The method according to claim 1 characterised in that after printing and before impregnation the stretched out fibre material or paper web is at least partially dried, whereby drying of the fibre material or paper web takes place by air and/or by ultra-violet radiation and/or by the method of near infra-red drying.

8. The method according to claim 1 characterised in that the printing of the fibre material or paper web is by digital printing or intaglio printing.

9. The method according to claim 1, which includes the further step of applying the coating element onto at least one carrier board, so as to produce a laminate.

10. The method according to claim 9, wherein the coating element is applied by glue or pressing methods.

11. A production installation for producing at least one coating element, comprising
an unrolling device for stretching out at least one fibre material or paper web by unrolling raw fibre material or raw paper, and
at least one printing device for printing the stretched out fibre material or paper web at least in parts with colour and/or at least one pattern/decoration,
at least one impregnating and/or coating device that is arranged in series with the printing device and is adapted for impregnating, at least in parts, the stretched out fibre material or paper web with at least one resin and or for coating, at least in parts, the stretched out fibre material or paper web with at least one resin.

12. The production installation according to claim 11, wherein the coating element is at least one decorative layer suitable for coating at least one carrier board.

13. The production installation according to claim 11, wherein the raw fibre material or raw paper is raw decorative paper.

14. The production installation according to claim 11, wherein the at least one resin is an aminoplastic and/or thermally hardening resin.

15. The production installation according to claim 14, wherein the at least one resin is melamine resin.

16. The production installation in accordance with claim 11, wherein the printing device is arranged between the unrolling device and the impregnating and/or coating device is adapted to print the fibre material or paper web by the method of digital printing or by the method of intaglio printing.

17. The production installation according to claim 11, which further includes at least one drying device allocated to the printing device or arranged in series with the printing device and the impregnating and/or coating device for at least partially drying the fibre material or paper web.

18. The production installation according to claim 17, wherein the at least one drying device is arranged between the printing device and the impregnating device.

19. The production installation according to claim 17, wherein the whereby drying of the fibre material or paper web takes place by air and/or by ultra-violet radiation and/or by the method of near infra-red drying.

20. The production installation according to claim 11, wherein the layer with resin contains fibre material.

21. The production installation according to claim 20, wherein the fibre material is cellulose and/or at least one abrasion-resistant or abrasive substance.

22. The production installation according to claim 21, wherein the at least one abrasion-resistant or abrasive substance is corundum.

23. A device for producing laminate, comprising
at least one production installation for producing at least one coating element comprising
an unrolling device for stretching out at least one fibre material or paper web by unrolling raw fibre material or raw paper, and
at least one printing device for printing the stretched out fibre material or paper web at least in parts with colour and/or at least one pattern/decoration,
at least one impregnating and/or coating device that is arranged in series with the printing device and is adapted for impregnating, at least in parts, the stretched out fibre material or paper web with at least one resin and or for coating, at least in parts, the stretched out fibre material or paper web with at least one resin
and
at least one lamination device adapted for applying the stretched out, printed, impregnated and/or coated fibre material or paper web, to at least one carrier board.
